(19) United States
(12) Patent Application Publication
(10) Pub. No.: US 2019/0372690 A1
(43) Pub. Date: Dec. 5, 2019

(54) USER EQUIPMENT HYSTERESIS FOR SIGNAL BLOCKAGE DETECTION

(71) Applicant: Intel Corporation, Santa Clara, CA (US)

(72) Inventors: Sarabjot SINGH, Santa Clara, CA (US); Jing ZHU, Portland, OR (US); Nageen HIMAYAT, Fremont, CA (US); Mustafa AKDENIZ, San Jose, CA (US)

(21) Appl. No.: 16/478,106

(22) PCT Filed: Feb. 9, 2018
(86) PCT No.: PCT/US2018/017555

§ 371 Date: Jul. 15, 2019

Related U.S. Application Data
(60) Provisional application No. 62/458,203, filed on Feb. 13, 2017.

(51) Int. Cl. H04B 17/336; H04L 1/00; H04W 76/27; H04L 12/26

(52) U.S. Cl. CPC H04B 17/336; H04L 1/0026; H04L 43/0852; H04W 76/27; H04L 1/0035

(57) ABSTRACT

Embodiments of the present disclosure may include determining a gap measurement based on signal-to-noise ratio (SNR) or channel quality indicator (CQI) feedback from a user equipment (UE), determining a hysteresis for the UE based on the gap measurement, where the hysteresis is a detection latency or a threshold for consecutive blockage detection signal (BDS) failures, and constructing a signal to be sent to the UE, the signal to include an indication of the hysteresis. Other embodiments may be described and/or claimed.

### RELATED APPLICATION

This application claims the benefit of priority of U.S. Provisional Patent Application Ser. No. 62/458,203, filed Feb. 13, 2017, entitled “LATENCY MINIMIZING BLOCKAGE DETECTION.” The disclosure of the provisional application is incorporated by reference herein in its entirety.

### TECHNICAL FIELD

The present disclosure relates generally to the field of wireless communications, and more specifically to millimeter-wave (mmWave) wireless signal blockage detection.

### BACKGROUND

The two key requirements for the next generation (5G) of wireless networks are to provide high peak rates and high edge rates. Millimeter-wave (mmWave) (at or above 28 GHz) communication is attractive for deployment in next generation wireless networks due to large available bandwidth catering to the first requirement. However, signal propagation in mmWave frequencies is highly sensitive to blocking caused by buildings, foliage, vehicular and pedestrian traffic, and self-blocking, making reliable communication challenging. In addition to dynamic blocking, signal variation may also be caused by Doppler/fast fading such as may be caused by small movements in the environment.

Legacy approaches to distinguishing between dynamic blocking and signal variation due to Doppler/fast fading are primarily static hysteresis based techniques, where a parameter N (fixed hysteresis) of consecutive physical downlink control channel (PDCCH), BPoll/B-RSP (referred to as blockage detection signals (BDS) hereafter) failures is used to detect blockage. A higher fixed hysteresis N may provide better detection accuracy, but at the cost of higher latency for detection.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a variation in signal-to-noise ratio (SNR) with time and associated blocking, in accordance with various embodiments.

FIG. 2 illustrates an average false alarm rate across users as a function of detection latency, in accordance with various embodiments.

FIG. 3 illustrates a distribution across user equipments (UEs) of a false alarm rate for static and adaptive cases, in accordance with some embodiments.

FIG. 4 illustrates a distribution of latency across UEs, in accordance with some embodiments.

FIG. 5 illustrates an architecture of a system of a network, in accordance with some embodiments.

FIG. 6 illustrates an architecture of a system of a network in accordance with some embodiments.

FIG. 7 illustrates example components of a device, in accordance with some embodiments.

FIG. 8 illustrates example interfaces of baseband circuitry, in accordance with some embodiments.

FIG. 9 is a block diagram illustrating components able to read instructions from a machine-readable or computer-readable medium and perform any one or more of the methodologies described in accordance with various embodiments.

FIG. 10 schematically illustrates a flow diagram for a process of determining a hysteresis for a UE based on a gap measurement, in accordance with various embodiments.

FIG. 11 schematically illustrates a flow diagram for a process of identifying a blockage event based on a determined detection latency or threshold for consecutive blockage detection signal (BDS) failures, in accordance with various embodiments.

### DETAILED DESCRIPTION

Some embodiments may relate to user equipment (UE) specific techniques for blockage detection that minimize detection latency without sacrificing detection performance. In various embodiments, the techniques may also apply to devices other than UEs such as infrastructure devices having links that are susceptible to blockage and fading.

In the following detailed description, reference is made to the accompanying drawings that form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other.

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail.

Embodiments herein may include one or more aspects that use an adaptive time hysteresis based technique for blockage detection. Various embodiments may include one or more of a gap based technique or a normalized gap based technique.

Some embodiments may include a gap based technique, where a lower hysteresis is used for UEs with a higher gap between their average signal-to-noise ratio (SNR) (or channel quality indicator (CQI)) and the outage SNR threshold (or lowest CQI). SNR and CQI are used interchangeably herein, assuming a one to one mapping across the two. In some embodiments, the outage SNR threshold may be a predetermined minimum threshold for communication.

Some embodiments may include a normalized gap based technique, where a lower hysteresis is used for UEs with a higher normalized gap, (e.g., the gap defined with respect to the gap based technique divided by the variability in SNR.)

In some embodiments, a wireless network may inform UEs of the detection latency. In various embodiments, this adaptive detection latency may be informed using UE specific dedicated signaling or through a broadcast signal where the mapping from CQI to hysteresis is specified to all UEs. In some embodiments, UEs with similar average CQI/SNR and/or standard deviation of SNR values may be grouped together, and a group specific time hysteresis may be specified by the network. While embodiments herein may describe a network assisted mechanism for UEs to minimize latency, similar functionality may apply to other network nodes that are susceptible to blockage and/or fading, any sender-receiver link that may be susceptible to blockage and/or fading, or some other scenario (e.g., relays transmitting to UE or to infrastructure, backhaul links, base station (BS) talking to other BS via backhaul links, a relay communicating with UEs or relays communicating with BS (infrastructure), and/or UEs communicating directly with other UEs.)

In some embodiments, a UE may calculate its own detection latency. In various embodiments, the UE may inform the network about its detection latency using any of the above specified signaling or any other suitable signaling technique. In some embodiments, it may be advantageous for the network to know about this latency in some cases, such as those that involve one or more synchronous procedures like beam adaptation post detection of blockage, where both the UE and BS switch to a pre-determined set of secondary beams upon detecting blockage.

In various embodiments, a hysteresis N may be made UE (or UE group) specific, with higher gap (or normalized gap) UEs using a lower number N (hence reducing their detection latency) without sacrificing detection accuracy.

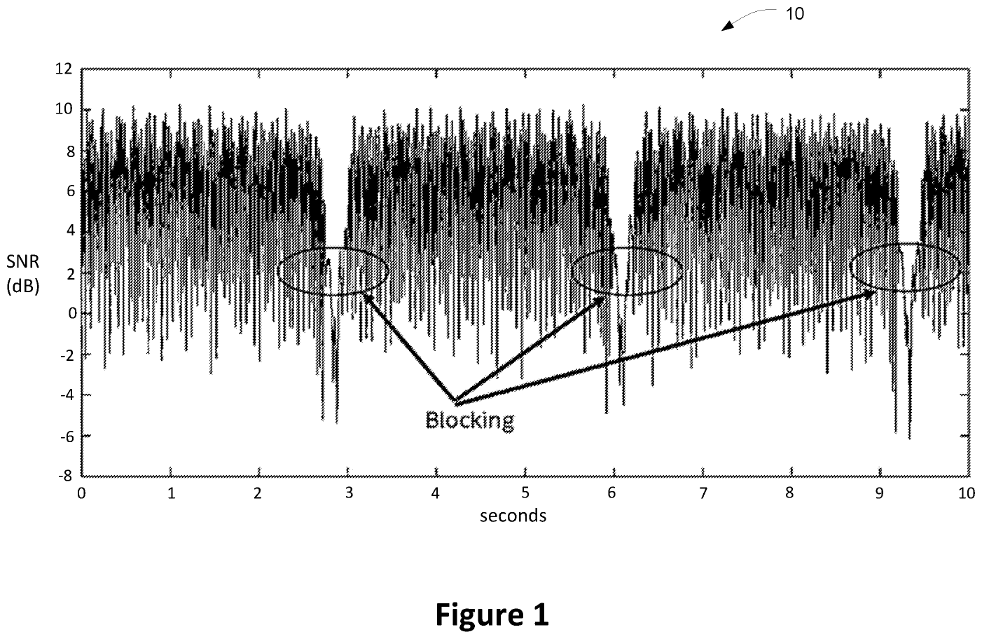

FIG. 1 illustrates a plot 10 showing a variation in signal-to-noise ratio (SNR) in decibels (dB) with time in seconds, and associated blocking, in accordance with various embodiments. In high frequency bands, like those used in mmWave communication, signal variation may occur due to fast fading (e.g., Doppler effects) and/or due to blocking. The variation due to fading is fast and not long lasting, whereas the attenuation due to blocking may last much longer (e.g., 200-300 milliseconds (ms) for a human blocker). The plot 10 shows the variation in SNR with time, with variations caused by blocking encircled.

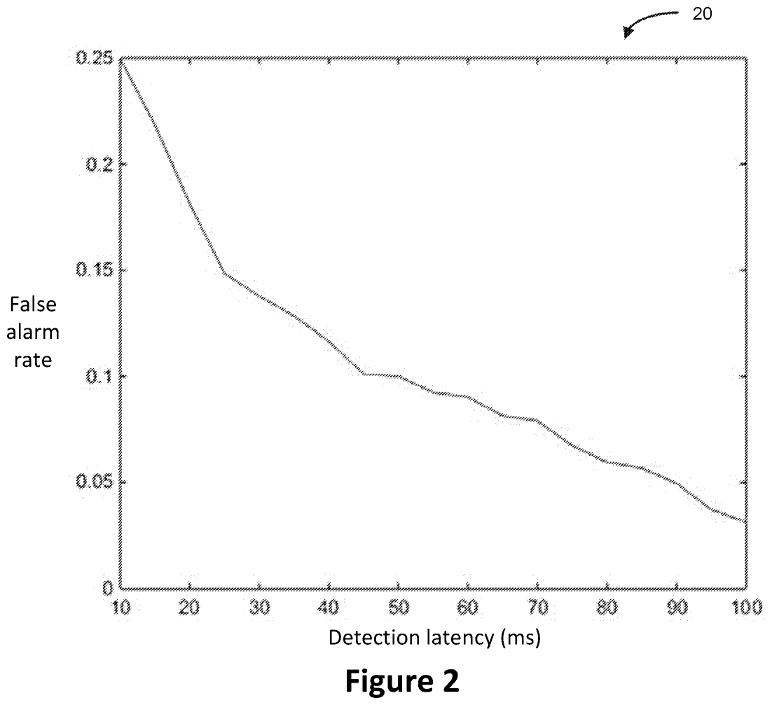

FIG. 2 illustrates a plot 20 showing an average false alarm rate across users as a function of detection latency (T) in milliseconds, in accordance with various embodiments.

Some legacy approaches may use a static, or fixed, hysteresis for all UEs that may detect if a blockage detection signal (BDS) fails consecutively for N times. Alternatively, failure of the BDS N times may imply that the SNR remains below a threshold for a consecutive T ms. In some embodiments, N and T may be interchangeable as T=N×periodicity of BDS (ms). Then the hysteresis used, (e.g., T), may be equivalent to the detection latency. A lower T may lead to a false alarm where a variation due to fading might be detected as blocking.

Various embodiments may include a user specific adaptive hysteresis. In some embodiments, a user specific detection latency (T) may be used. In various embodiments, the user specific detection latency may be gap based or normalized gap based. Some embodiments may include a gap based user specific detection latency, where detection latency is made inversely proportional lower to the gap between an average SNR of a UE (SNRav) and the outage threshold (SNRthresh), with the gap measurement calculated as: Gap=SNRav−SNRthresh. Some embodiments may include a normalized gap based user specific detection latency, where detection latency is made inversely to a normalized gap, with the normalized gap calculated as: Normalized Gap=Gap/std(SNR), where std( ) is the standard deviation operator.

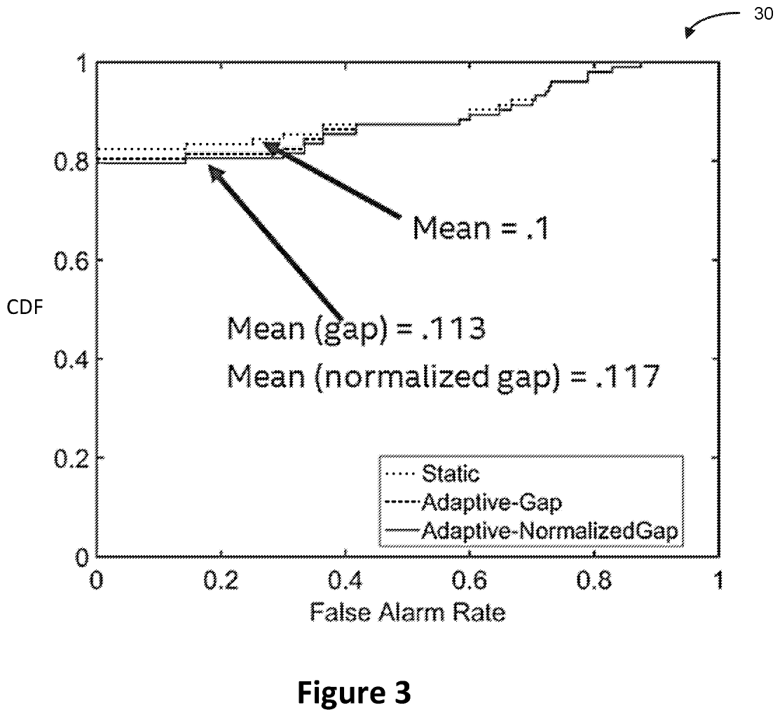

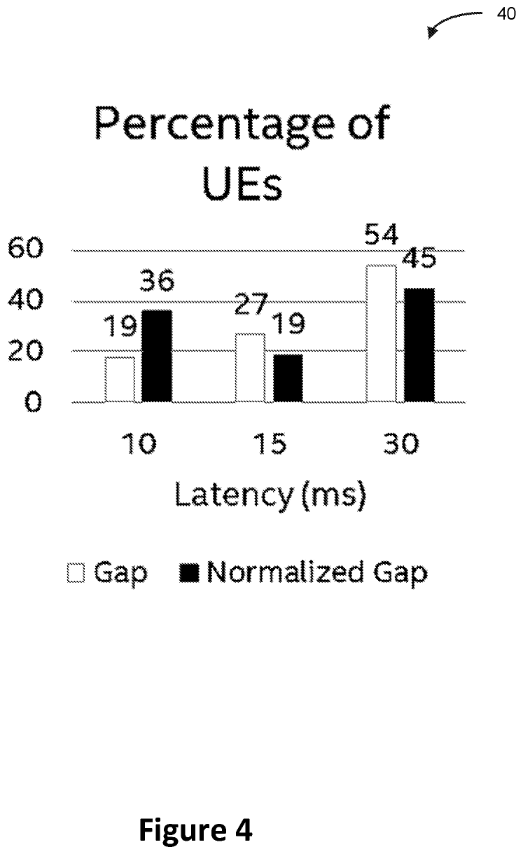

As an example, for the simulated results shown in FIGS. 3 and 4:
T=10 ms is used for UEs with a gap of 10 dB or larger for the gap based approach, and for UEs with a normalized gap of 2 or larger.
T=15 ms is used for UEs with a gap between 5 to 10 dB for the gap based approach, and for UEs with a normalized gap between 1 and 2.
T=30 ms is used for the rest of UEs.

For comparison of the adaptive approaches with the static case in FIG. 3, all UEs for the static case are configured with the same latency of 30 ms. The outage threshold for SNR (SNRthresh) is assumed to be −2 dB.

FIG. 3 illustrates a plot 30 showing a cumulative distribution function (CDF) across user equipments (UEs) of a false alarm rate for static and adaptive cases, in accordance with some embodiments. Both gap based and normalized gap based approaches are shown in comparison to the static case. As can be seen, the false alarm rate difference is minimal between the two schemes (static and adaptive), leading to similar blockage detection performance. However, from a latency point of view, the schemes of various embodiments herein may outperform the static scheme as shown in FIG. 4.

FIG. 4 illustrates a chart 40 showing a distribution of latency in milliseconds across UEs for gap based and normalized gap based approaches, in accordance with some embodiments. As can be seen, an adaptive approach using a normalized gap based approach reduces detection latency for more than 50% of users over the baseline case's latency of 30 ms, with 36% of UEs having a latency of 10 ms and 19% of UEs having a latency of 15 ms. An adaptive approach using a gap based approach reduces detection latency for 46% of users over the baseline case's latency of 30 ms, with 19% of UEs having a latency of 10 ms and 27% of UEs having a latency of 15 ms.

The latency/hysteresis determination procedure and signaling flow may differ in various embodiments. In some embodiments, a UE may calculate its own latency/hysteresis using the SNR statistics as described above. In some embodiments, the UE may share this information with a network (e.g., an access node such as an evolved Node B (eNB) or a next generation node B (gNB)), where it might help perform synchronous blockage detection at the network and the UE. In some embodiments, the detection latency chosen by the UE may be fed back to the network by piggybacking on the regular feedback procedures like CQI/ACK.

In some embodiments, an eNB or other access node (e.g., gNB) may estimate the UE specific latency/hysteresis using the SNR/CQI feedback from the UE. The eNB may then estimate the standard deviation of SNR using this feedback. In some embodiments, the eNB may then inform UEs of the detection latency (T) or the threshold for consecutive BDS failures N to be used by each UE. This could be informed through unicast signals or through group specific signals where all UEs belonging to a specific group use the same hysteresis. In some embodiments, these groups may be formed by grouping UEs with similar gaps (or normalized gaps) together. Alternatively, in some embodiments, the eNB may broadcast a table mapping CQI to N in the system information broadcast.

In some embodiments, the above techniques may be used to compute a maximum hysteresis (N) to be used by each UE. Consequently, the actual N used by the UE may be based on a moving average of observed BDS burst losses. In some situations, the actual hysteresis may be reduced compared to the maximum N, and the UE may revert back to the maximum N periodically. The same procedure may be used at the network side in various embodiments.

While a specific metric with a specific hysteresis mechanism is described in embodiments herein, the ideas herein are broadly applicable to alternate metrics for blockage detection and more general hysteresis mechanisms. For instance, in some embodiments, a moving average or more robust metrics such as the median, weighted order statistics, or any other suitable metric may be computed over a specified window duration and compared to an outage threshold. In some embodiments, the hysteresis may be specified as a total time duration where the blockage condition is expected to hold. Further, in some embodiments, the network may configure a particular technique to use for blockage detection as well as hysteresis via signaling.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware. Embodiments described herein may be implemented into a system using any suitably configured hardware and/or software.

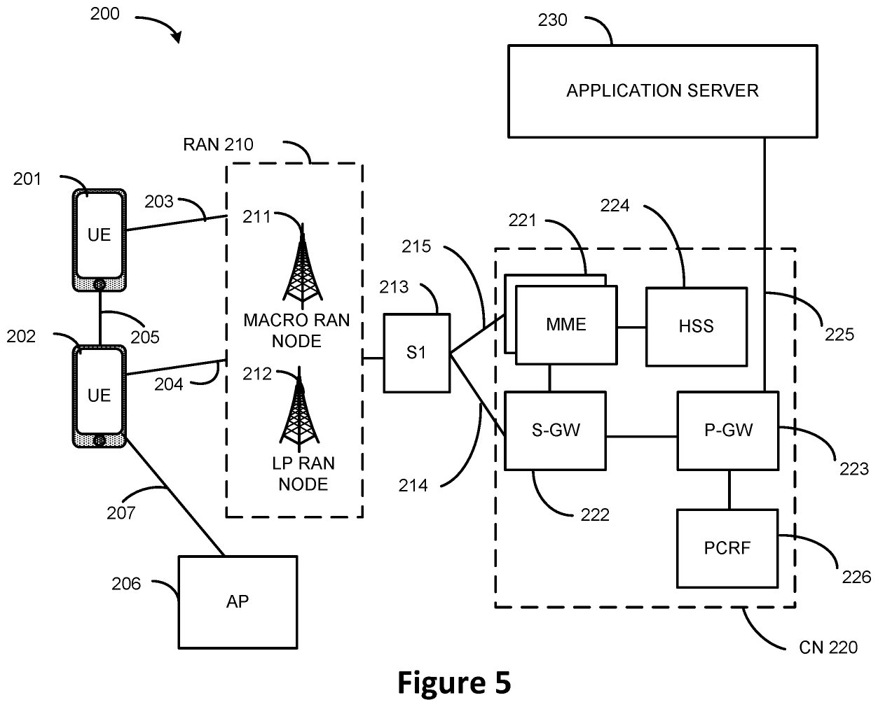

FIG. 5 illustrates an architecture of a system 200 of a network in accordance with some embodiments. The system 200 is shown to include a user equipment (UE) 201 and a UE 202. The UEs 201 and 202 are illustrated as smartphones (e.g., handheld touchscreen mobile computing devices connectable to one or more cellular networks), but may also comprise any mobile or non-mobile computing device, such as Personal Data Assistants (PDAs), pagers, laptop computers, desktop computers, wireless handsets, or any computing device including a wireless communications interface.

In some embodiments, any of the UEs 201 and 202 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 201 and 202 may be configured to connect, e.g., communicatively couple, with a radio access network (RAN) 210—the RAN 210 may be, for example, an Evolved Universal Mobile Telecommunications System (UMTS) Terrestrial Radio Access Network (E-UTRAN), a NextGen RAN (NG RAN), or some other type of RAN. The UEs 201 and 202 utilize connections 203 and 204, respectively, each of which comprises a physical communications interface or layer (discussed in further detail below); in this example, the connections 203 and 204 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UEs 201 and 202 may further directly exchange communication data via a ProSe interface 205. The ProSe interface 205 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 202 is shown to be configured to access an access point (AP) 206 via connection 207. The connection 207 can comprise a local wireless connection, such as a connection consistent with any IEEE 802.11 protocol, wherein the AP 206 would comprise a wireless fidelity (WiFi®) router. In this example, the AP 206 is shown to be connected to the Internet without connecting to the core network of the wireless system (described in further detail below).

The RAN 210 can include one or more access nodes that enable the connections 203 and 204. These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). The RAN 210 may include one or more RAN nodes for providing macrocells, e.g., macro RAN node 211, and one or more RAN nodes for providing femtocells or picocells (e.g., cells having smaller coverage areas, smaller user capacity, or higher bandwidth compared to macrocells), e.g., low power (LP) RAN node 212.

Any of the RAN nodes 211 and 212 can terminate the air interface protocol and can be the first point of contact for the UEs 201 and 202. In some embodiments, any of the RAN nodes 211 and 212 can fulfill various logical functions for the RAN 210 including, but not limited to, radio network controller (RNC) functions such as radio bearer management, uplink and downlink dynamic radio resource management and data packet scheduling, and mobility management.

In accordance with some embodiments, the UEs 201 and 202 can be configured to communicate using Orthogonal Frequency-Division Multiplexing (OFDM) communication signals with each other or with any of the RAN nodes 211 and 212 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 211 and 212 to the UEs 201 and 202, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UEs 201 and 202. The physical downlink control channel (PDCCH) may carry information about the transport format and resource allocations related to the PDSCH channel, among other things. It may also inform the UEs 201 and 202 about the transport format, resource allocation, and H-ARQ (Hybrid Automatic Repeat Request) information related to the uplink shared channel. Typically, downlink scheduling (assigning control and shared channel resource blocks to the UE 102 within a cell) may be performed at any of the RAN nodes 211 and 212 based on channel quality information fed back from any of the UEs 201 and 202. The downlink resource assignment information may be sent on the PDCCH used for (e.g., assigned to) each of the UEs 201 and 202.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as an enhanced resource element groups (EREGs). An ECCE may have other numbers of EREGs in some situations.

The RAN 210 is shown to be communicatively coupled to a core network (CN) 220—via an S1 interface 213. In embodiments, the CN 220 may be an evolved packet core (EPC) network, a NextGen Packet Core (NPC) network, or some other type of CN. In this embodiment the S1 interface 213 is split into two parts: the S1-U interface 214, which carries traffic data between the RAN nodes 211 and 212 and the serving gateway (S-GW) 222, and the S1-mobility management entity (MME) interface 215, which is a signaling interface between the RAN nodes 211 and 212 and MMEs 221.

In this embodiment, the CN 220 comprises the MMEs 221, the S-GW 222, the Packet Data Network (PDN) Gateway (P-GW) 223, and a home subscriber server (HSS) 224. The MMEs 221 may be similar in function to the control plane of legacy Serving General Packet Radio Service (GPRS) Support Nodes (SGSN). The MMEs 221 may manage mobility aspects in access such as gateway selection and tracking area list management. The HSS 224 may comprise a database for network users, including subscription-related information to support the network entities' handling of communication sessions. The CN 220 may comprise one or several HSSs 224, depending on the number of mobile subscribers, on the capacity of the equipment, on the organization of the network, etc. For example, the HSS 224 can provide support for routing/roaming, authentication, authorization, naming/addressing resolution, location dependencies, etc.

The S-GW 222 may terminate the S1 interface 213 towards the RAN 210, and routes data packets between the RAN 210 and the CN 220. In addition, the S-GW 222 may be a local mobility anchor point for inter-RAN node handovers and also may provide an anchor for inter-3GPP mobility. Other responsibilities may include lawful intercept, charging, and some policy enforcement.

The P-GW 223 may terminate an SGi interface toward a PDN. The P-GW 223 may route data packets between the EPC network 223 and external networks such as a network including the application server 230 (alternatively referred to as application function (AF)) via an Internet Protocol (IP) interface 225. Generally, the application server 230 may be an element offering applications that use IP bearer resources with the core network (e.g., UMTS Packet Services (PS) domain, LTE PS data services, etc.). In this embodiment, the P-GW 223 is shown to be communicatively coupled to an application server 230 via an IP communications interface 225. The application server 230 can also be configured to support one or more communication services (e.g., Voice-over-Internet Protocol (VoIP) sessions, PTT sessions, group communication sessions, social networking services, etc.) for the UEs 201 and 202 via the CN 220.

The P-GW 223 may further be a node for policy enforcement and charging data collection. Policy and Charging Enforcement Function (PCRF) 226 is the policy and charging control element of the CN 220. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 226 may be communicatively coupled to the application server 230 via the P-GW 223. The application server 230 may signal the PCRF 226 to indicate a new service flow and select the appropriate Quality of Service (QoS) and charging parameters. The PCRF 226 may provision this rule into a Policy and Charging Enforcement Function (PCEF) (not shown) with the appropriate traffic flow template (TFT) and QoS class of identifier (QCI), which commences the QoS and charging as specified by the application server 230.

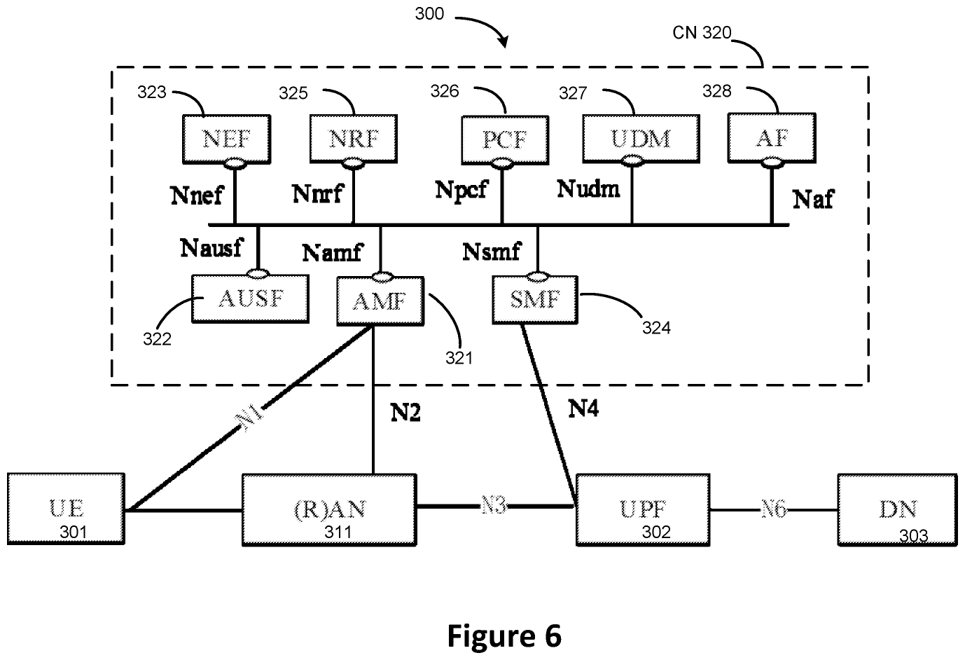

FIG. 6 illustrates an architecture of a system 300 of a network in accordance with some embodiments. The system 300 is shown to include a UE 301, which may be the same or similar to UEs 201 and 202 discussed previously; a RAN node 311, which may be the same or similar to RAN nodes 211 and 212 discussed previously; a User Plane Function (UPF) 302; a Data network (DN) 303, which may be, for example, operator services, Internet access or 3rd party services; and a 5G Core Network (5GC or CN) 320.

The CN 320 may include an Authentication Server Function (AUSF) 322; a Core Access and Mobility Management Function (AMF) 321; a Session Management Function (SMF) 324; a Network Exposure Function (NEF) 323; a Policy Control function (PCF) 326; a Network Function (NF) Repository Function (NRF) 325; a Unified Data Management (UDM) 327; and an Application Function (AF) 328. The CN 320 may also include other elements that are not shown, such as a Structured Data Storage network function (SDSF), an Unstructured Data Storage network function (UDSF), and the like.

The UPF 302 may act as an anchor point for intra-RAT and inter-RAT mobility, an external PDU session point of interconnect to DN 303, and a branching point to support multi-homed PDU session. The UPF 302 may also perform packet routing and forwarding, packet inspection, enforce user plane part of policy rules, lawfully intercept packets (UP collection); traffic usage reporting, perform QoS handling for user plane (e.g. packet filtering, gating, UL/DL rate enforcement), perform Uplink Traffic verification (e.g., SDF to QoS flow mapping), transport level packet marking in the uplink and downlink, and downlink packet buffering and downlink data notification triggering. UPF 302 may include an uplink classifier to support routing traffic flows to a data network. The DN 303 may represent various network operator services, Internet access, or third party services. NY 303 may include, or be similar to application server 230 discussed previously.

The AUSF 322 may store data for authentication of UE 301 and handle authentication related functionality. The AUSF 322 may facilitate a common authentication framework for various access types.

The AMF 321 may be responsible for registration management (e.g., for registering UE 301, etc.), connection management, reachability management, mobility management, and lawful interception of AMF-related events, and access authentication and authorization. AMF 321 may provide transport for SM messages between and SMF 324, and act as a transparent proxy for routing SM messages. AMF 321 may also provide transport for short message service (SMS) messages between UE 301 and an SMS function (SMSF) (not shown by FIG. 6). AMF 321 may act as Security Anchor Function (SEA), which may include interaction with the AUSF 322 and the UE 301, receipt of an intermediate key that was established as a result of the UE 301 authentication process. Where USIM based authentication is used, the AMF 321 may retrieve the security material from the AUSF 322. AMF 321 may also include a Security Context Management (SCM) function, which receives a key from the SEA that it uses to derive access-network specific keys. Furthermore, AMF 321 may be a termination point of RAN CP interface (N2 reference point), a termination point of NAS (N1) signalling, and perform NAS ciphering and integrity protection.

AMF 321 may also support NAS signalling with a UE 301 over an N3 interworking-function (IWF) interface. The N3IWF may be used to provide access to untrusted entities. N33IWF may be a termination point for the N2 and N3 interfaces for control plane and user plane, respectively, and as such, may handle N2 signalling from SMF and AMF for PDU sessions and QoS, encapsulate/de-encapsulate packets for IPSec and N3 tunnelling, mark N3 user-plane packets in the uplink, and enforce QoS corresponding to N3 packet marking taking into account QoS requirements associated to such marking received over N2. N3IWF may also relay uplink and downlink control-plane NAS (N1) signalling between the UE 301 and AMF 321, and relay uplink and downlink user-plane packets between the UE 301 and UPF 302. The N3IWF also provides mechanisms for IPsec tunnel establishment with the UE 301.

The SMF 324 may be responsible for session management (e.g., session establishment, modify and release, including tunnel maintain between UPF and AN node); UE IP address allocation & management (including optional Authorization); Selection and control of UP function; Configures traffic steering at UPF to route traffic to proper destination; termination of interfaces towards Policy control functions; control part of policy enforcement and QoS; lawful intercept (for SM events and interface to LI System); termination of SM parts of NAS messages; downlink Data Notification; initiator of AN specific SM information, sent via AMF over N2 to AN; determine SSC mode of a session. The SMF 324 may include the following roaming functionality: handle local enforcement to apply QoS SLAB (VPLMN); charging data collection and charging interface (VPLMN); lawful intercept (in VPLMN for SM events and interface to LI System); support for interaction with external DN for transport of signalling for PDU session authorization/authentication by external DN.

The NEF 323 may provide means for securely exposing the services and capabilities provided by 3GPP network functions for third party, internal exposure/re-exposure, Application Functions (e.g., AF 328), edge computing or fog computing systems, etc. In such embodiments, the NEF 323 may authenticate, authorize, and/or throttle the AFs. NEF 323 may also translate information exchanged with the AF 328 and information exchanged with internal network functions. For example, the NEF 323 may translate between an AF-Service-Identifier and an internal 5GC information. NEF 323 may also receive information from other network functions (NFs) based on exposed capabilities of other network functions. This information may be stored at the NEF 323 as structured data, or at a data storage NF using a standardized interfaces. The stored information can then be re-exposed by the NEF 323 to other NFs and AFs, and/or used for other purposes such as analytics.

The NRF 325 may support service discovery functions, receive NF Discovery Requests from NF instances, and provide the information of the discovered NF instances to the NF instances. NRF 325 also maintains information of available NF instances and their supported services.

The PCF 326 may provide policy rules to control plane function(s) to enforce them, and may also support unified policy framework to govern network behaviour. The PCF 326 may also implement a front end (FE) to access subscription information relevant for policy decisions in a UDR of UDM 327.

The UDM 327 may handle subscription-related information to support the network entities' handling of communication sessions, and may store subscription data of UE 301. The UDM 327 may include two parts, an application FE and a User Data Repository (UDR). The UDM may include a UDM FE, which is in charge of processing of credentials, location management, subscription management and so on. Several different front ends may serve the same user in different transactions. The UDM-FE accesses subscription information stored in the UDR and performs authentication credential processing; user identification handling; access authorization; registration/mobility management; and subscription management. The UDR may interact with PCF 326. UDM 327 may also support SMS management, wherein an SMS-FE implements the similar application logic as discussed previously.

The AF 328 may provide application influence on traffic routing, access to the Network Capability Exposure (NCE), and interact with the policy framework for policy control. The NCE may be a mechanism that allows the 5GC and AF 328 to provide information to each other via NEF 323, which may be used for edge computing implementations. In such implementations, the network operator and third party services may be hosted close to the UE 301 access point of attachment to achieve an efficient service delivery through the reduced end-to-end latency and load on the transport network. For edge computing implementations, the 5GC may select a UPF 302 close to the UE 301 and execute traffic steering from the UPF 302 to DN 303 via the N6 interface. This may be based on the UE subscription data, UE location, and information provided by the AF 328. In this way, the AF 328 may influence UPF (re)selection and traffic routing. Based on operator deployment, when AF 328 is considered to be a trusted entity, the network operator may permit AF 328 to interact directly with relevant NFs.

As discussed previously, the CN 320 may include an SMSF, which may be responsible for SMS subscription checking and verification, and relaying SM messages to/from the UE 301 to/from other entities, such as an SMS-GMSC/IWMSC/SMS-router. The SMS may also interact with AMF 321 and UDM 327 for notification procedure that the UE 301 is available for SMS transfer (e.g., set a UE not reachable flag, and notifying UDM 327 when UE 301 is available for SMS).

The system 300 may include the following service-based interfaces: Namf: Service-based interface exhibited by AMF; Nsmf: Service-based interface exhibited by SMF; Nnef: Service-based interface exhibited by NEF; Npcf: Service-based interface exhibited by PCF; Nudm: Service-based interface exhibited by UDM; Naf: Service-based interface exhibited by AF; Nnrf: Service-based interface exhibited by NRF; and Nausf: Service-based interface exhibited by AUSF.

The system 300 may include the following reference points: N1: Reference point between the UE and the AMF; N2: Reference point between the (R)AN and the AMF; N3: Reference point between the (R)AN and the UPF; N4: Reference point between the SMF and the UPF; and N6: Reference point between the UPF and a Data Network. There may be many more reference points and/or service-based interfaces between the NF services in the NFs, however, these interfaces and reference points have been omitted for clarity. For example, an N5 reference point may be between the PCF and the AF; an N7 reference point may be between the PCF and the SMF; an N11 reference point between the AMF and SMF; etc. In some embodiments, the CN 320 may include an Nx interface, which is an inter-CN interface between the MME (e.g., MME 221) and the AMF 321 in order to enable interworking between CN 320 and CN 220.

Although not shown by FIG. 6, system 300 may include multiple RAN nodes 311 wherein an Xn interface is defined between two or more RAN nodes 311 (e.g., gNBs and the like) that connecting to 5GC 320, between a RAN node 311 (e.g., gNB) connecting to 5GC 320 and an eNB (e.g., a RAN node 211 of FIG. 5), and/or between two eNBs connecting to 5GC 320.

In some implementations, the Xn interface may include an Xn user plane (Xn-U) interface and an Xn control plane (Xn-C) interface. The Xn-U may provide non-guaranteed delivery of user plane PDUs and support/provide data forwarding and flow control functionality. The Xn-C may provide management and error handling functionality, functionality to manage the Xn-C interface; mobility support for UE 301 in a connected mode (e.g., CM-CONNECTED) including functionality to manage the UE mobility for connected mode between one or more RAN nodes 311. The mobility support may include context transfer from an old (source) serving RAN node 311 to new (target) serving RAN node 311; and control of user plane tunnels between old (source) serving RAN node 311 to new (target) serving RAN node 311.

A protocol stack of the Xn-U may include a transport network layer built on Internet Protocol (IP) transport layer, and a GTP-U layer on top of a UDP and/or IP layer(s) to carry user plane PDUs. The Xn-C protocol stack may include an application layer signaling protocol (referred to as Xn Application Protocol (Xn-AP)) and a transport network layer that is built on an SCTP layer. The SCTP layer may be on top of an IP layer. The SCTP layer provides the guaranteed delivery of application layer messages. In the transport IP layer point-to-point transmission is used to deliver the signaling PDUs. In other implementations, the Xn-U protocol stack and/or the Xn-C protocol stack may be same or similar to the user plane and/or control plane protocol stack(s) shown and described herein.

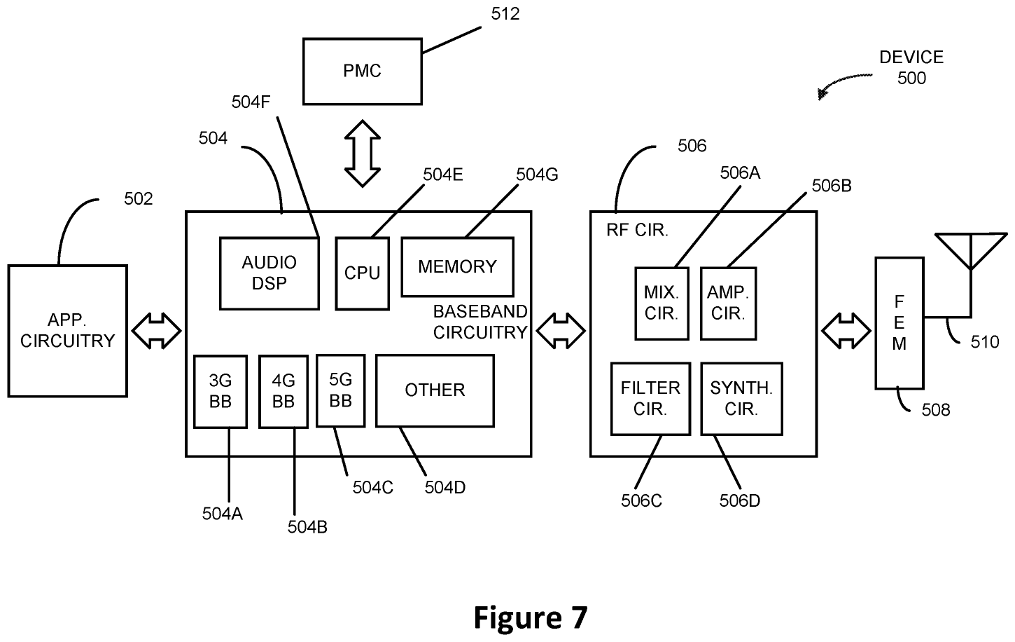

FIG. 7 illustrates example components of a device 500 in accordance with some embodiments. In some embodiments, the device 500 may include application circuitry 502, baseband circuitry 504, Radio Frequency (RF) circuitry 506, front-end module (FEM) circuitry 508, one or more antennas 510, and power management circuitry (PMC) 512 coupled together at least as shown. The components of the illustrated device 500 may be included in a UE or a RAN node. In some embodiments, the device 500 may include less elements (e.g., a RAN node may not utilize application circuitry 502, and instead include a processor/controller to process IP data received from an EPC). In some embodiments, the device 500 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 502 may include one or more application processors. For example, the application circuitry 502 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 500. In some embodiments, processors of application circuitry 502 may process IP data packets received from an EPC.

The baseband circuitry 504 may include circuitry such as, but not limited to, one or more single-core or multi-core processors. The baseband circuitry 504 may include one or more baseband processors or control logic to process baseband signals received from a receive signal path of the RF circuitry 506 and to generate baseband signals for a transmit signal path of the RF circuitry 506. Baseband processing circuity 504 may interface with the application circuitry 502 for generation and processing of the baseband signals and for controlling operations of the RF circuitry 506. For example, in some embodiments, the baseband circuitry 504 may include a third generation (3G) baseband processor 504A, a fourth generation (4G) baseband processor 504B, a fifth generation (5G) baseband processor 504C, or other baseband processor(s) 504D for other existing generations, generations in development or to be developed in the future (e.g., second generation (2G), sixth generation (6G), etc.). The baseband circuitry 504 (e.g., one or more of baseband processors 504A-D) may handle various radio control functions that enable communication with one or more radio networks via the RF circuitry 506. In other embodiments, some or all of the functionality of baseband processors 504A-D may be included in modules stored in the memory 504G and executed via a Central Processing Unit (CPU) 504E. The radio control functions may include, but are not limited to, signal modulation/demodulation, encoding/decoding, radio frequency shifting, etc. In some embodiments, modulation/demodulation circuitry of the baseband circuitry 504 may include Fast-Fourier Transform (FFT), precoding, or constellation mapping/demapping functionality. In some embodiments, encoding/decoding circuitry of the baseband circuitry 504 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 504 may include one or more audio digital signal processor(s) (DSP) 504F. The audio DSP(s) 504F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 504 and the application circuitry 502 may be implemented together such as, for example, on a system on a chip (SOC).

In some embodiments, the baseband circuitry 504 may provide for communication compatible with one or more radio technologies. For example, in some embodiments, the baseband circuitry 504 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 504 is configured to support radio communications of more than one wireless protocol may be referred to as multi-mode baseband circuitry.

RF circuitry 506 may enable communication with wireless networks using modulated electromagnetic radiation through a non-solid medium. In various embodiments, the RF circuitry 506 may include switches, filters, amplifiers, etc. to facilitate the communication with the wireless network. RF circuitry 506 may include a receive signal path which may include circuitry to down-convert RF signals received from the FEM circuitry 508 and provide baseband signals to the baseband circuitry 504. RF circuitry 506 may also include a transmit signal path which may include circuitry to up-convert baseband signals provided by the baseband circuitry 504 and provide RF output signals to the FEM circuitry 508 for transmission.

In some embodiments, the receive signal path of the RF circuitry 506 may include mixer circuitry 506a, amplifier circuitry 506b and filter circuitry 506c. In some embodiments, the transmit signal path of the RF circuitry 506 may include filter circuitry 506c and mixer circuitry 506a. RF circuitry 506 may also include synthesizer circuitry 506d for synthesizing a frequency for use by the mixer circuitry 506a of the receive signal path and the transmit signal path. In some embodiments, the mixer circuitry 506a of the receive signal path may be configured to down-convert RF signals received from the FEM circuitry 508 based on the synthesized frequency provided by synthesizer circuitry 506d. The amplifier circuitry 506b may be configured to amplify the down-converted signals and the filter circuitry 506c may be a low-pass filter (LPF) or band-pass filter (BPF) configured to remove unwanted signals from the down-converted signals to generate output baseband signals. Output baseband signals may be provided to the baseband circuitry 504 for further processing. In some embodiments, the output baseband signals may be zero-frequency baseband signals, although this is not a requirement. In some embodiments, mixer circuitry 506a of the receive signal path may comprise passive mixers, although the scope of the embodiments is not limited in this respect.

In some embodiments, the mixer circuitry 506a of the transmit signal path may be configured to up-convert input baseband signals based on the synthesized frequency provided by the synthesizer circuitry 506d to generate RF output signals for the FEM circuitry 508. The baseband signals may be provided by the baseband circuitry 504 and may be filtered by filter circuitry 506c.

In some embodiments, the mixer circuitry 506a of the receive signal path and the mixer circuitry 506a of the transmit signal path may include two or more mixers and may be arranged for quadrature downconversion and upconversion, respectively. In some embodiments, the mixer circuitry 506a of the receive signal path and the mixer circuitry 506a of the transmit signal path may include two or more mixers and may be arranged for image rejection (e.g., Hartley image rejection). In some embodiments, the mixer circuitry 506a of the receive signal path and the mixer circuitry 506a may be arranged for direct downconversion and direct upconversion, respectively. In some embodiments, the mixer circuitry 506a of the receive signal path and the mixer circuitry 506a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 506 may include analog-to-digital converter (ADC) and digital-to-analog converter (DAC) circuitry and the baseband circuitry 504 may include a digital baseband interface to communicate with the RF circuitry 506.

In some dual-mode embodiments, a separate radio IC circuitry may be provided for processing signals for each spectrum, although the scope of the embodiments is not limited in this respect.

In some embodiments, the synthesizer circuitry 506d may be a fractional-N synthesizer or a fractional N/N+1 synthesizer, although the scope of the embodiments is not limited in this respect as other types of frequency synthesizers may be suitable. For example, synthesizer circuitry 506d may be a delta-sigma synthesizer, a frequency multiplier, or a synthesizer comprising a phase-locked loop with a frequency divider.

The synthesizer circuitry 506d may be configured to synthesize an output frequency for use by the mixer circuitry 506a of the RF circuitry 506 based on a frequency input and a divider control input. In some embodiments, the synthesizer circuitry 506d may be a fractional N/N+1 synthesizer.

In some embodiments, frequency input may be provided by a voltage controlled oscillator (VCO), although that is not a requirement. Divider control input may be provided by either the baseband circuitry 504 or the applications processor 502 depending on the desired output frequency. In some embodiments, a divider control input (e.g., N) may be determined from a look-up table based on a channel indicated by the applications processor 502.

Synthesizer circuitry 506d of the RF circuitry 506 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 506d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 506 may include an IQ/polar converter.

FEM circuitry 508 may include a receive signal path which may include circuitry configured to operate on RF signals received from one or more antennas 510, amplify the received signals and provide the amplified versions of the received signals to the RF circuitry 506 for further processing. FEM circuitry 508 may also include a transmit signal path which may include circuitry configured to amplify signals for transmission provided by the RF circuitry 506 for transmission by one or more of the one or more antennas 510. In various embodiments, the amplification through the transmit or receive signal paths may be done solely in the RF circuitry 506, solely in the FEM 508, or in both the RF circuitry 506 and the FEM 508.

In some embodiments, the FEM circuitry 508 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 506). The transmit signal path of the FEM circuitry 508 may include a power amplifier (PA) to amplify input RF signals (e.g., provided by RF circuitry 506), and one or more filters to generate RF signals for subsequent transmission (e.g., by one or more of the one or more antennas 510).

In some embodiments, the PMC 512 may manage power provided to the baseband circuitry 504. In particular, the PMC 512 may control power-source selection, voltage scaling, battery charging, or DC-to-DC conversion. The PMC 512 may often be included when the device 500 is capable of being powered by a battery, for example, when the device is included in a UE. The PMC 512 may increase the power conversion efficiency while providing desirable implementation size and heat dissipation characteristics.

While FIG. 7 shows the PMC 512 coupled only with the baseband circuitry 504. However, in other embodiments, the PMC 512 may be additionally or alternatively coupled with, and perform similar power management operations for, other components such as, but not limited to, application circuitry 502, RF circuitry 506, or FEM 508.

In some embodiments, the PMC 512 may control, or otherwise be part of, various power saving mechanisms of the device 500. For example, if the device 500 is in an RRC_Connected state, where it is still connected to the RAN node as it expects to receive traffic shortly, then it may enter a state known as Discontinuous Reception Mode (DRX) after a period of inactivity. During this state, the device 500 may power down for brief intervals of time and thus save power.

If there is no data traffic activity for an extended period of time, then the device 500 may transition off to an RRC_Idle state, where it disconnects from the network and does not perform operations such as channel quality feedback, handover, etc. The device 500 goes into a very low power state and it performs paging where again it periodically wakes up to listen to the network and then powers down again. The device 500 may not receive data in this state, in order to receive data, it must transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 502 and processors of the baseband circuitry 504 may be used to execute elements of one or more instances of a protocol stack. For example, processors of the baseband circuitry 504, alone or in combination, may be used execute Layer 3, Layer 2, or Layer 1 functionality, while processors of the application circuitry 504 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

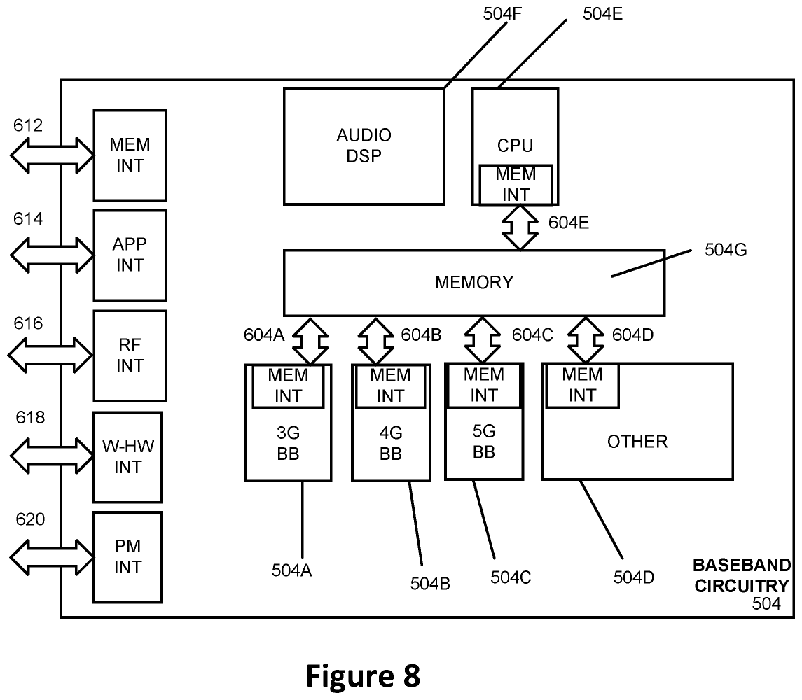

FIG. 8 illustrates example interfaces of baseband circuitry in accordance with some embodiments. As discussed above, the baseband circuitry 504 of FIG. 7 may comprise processors 504A-504E and a memory 504G utilized by said processors. Each of the processors 504A-504E may include a memory interface, 604A-604E, respectively, to send/receive data to/from the memory 504G.

The baseband circuitry 504 may further include one or more interfaces to communicatively couple to other circuitries/devices, such as a memory interface 612 (e.g., an interface to send/receive data to/from memory external to the baseband circuitry 504), an application circuitry interface 614 (e.g., an interface to send/receive data to/from the application circuitry 502 of FIG. 7), an RF circuitry interface 616 (e.g., an interface to send/receive data to/from RF circuitry 506 of FIG. 7), a wireless hardware connectivity interface 618 (e.g., an interface to send/receive data to/from Near Field Communication (NFC) components, Bluetooth® components (e.g., Bluetooth® Low Energy), Wi-Fi® components, and other communication components), and a power management interface 620 (e.g., an interface to send/receive power or control signals to/from the PMC 512.

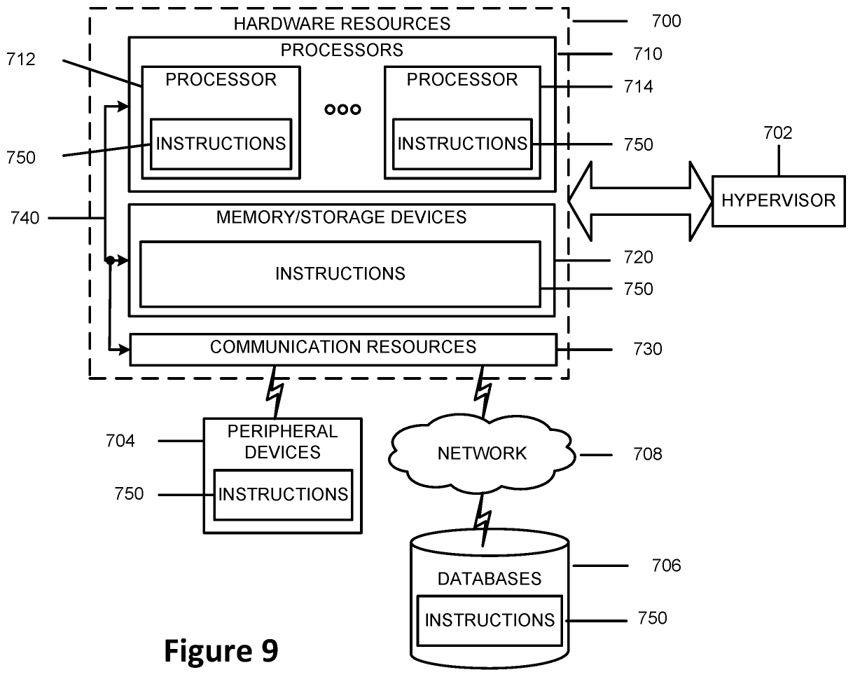

FIG. 9 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 9 shows a diagrammatic representation of hardware resources 700 including one or more processors (or processor cores) 710, one or more memory/storage devices 720, and one or more communication resources 730, each of which may be communicatively coupled via a bus 740. For embodiments where node virtualization (e.g., NFV) is utilized, a hypervisor 702 may be executed to provide an execution environment for one or more network slices/sub-slices to utilize the hardware resources 700

The processors 710 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 712 and a processor 714.

The memory/storage devices 720 may include main memory, disk storage, or any suitable combination thereof. The memory/storage devices 720 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 730 may include interconnection or network interface components or other suitable devices to communicate with one or more peripheral devices 704 or one or more databases 706 via a network 708. For example, the communication resources 730 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 750 may comprise software, a program, an application, an applet, an app, or other executable code for causing at least any of the processors 710 to perform any one or more of the methodologies discussed herein. The instructions 750 may reside, completely or partially, within at least one of the processors 710 (e.g., within the processor's cache memory), the memory/storage devices 720, or any suitable combination thereof. Furthermore, any portion of the instructions 750 may be transferred to the hardware resources 700 from any combination of the peripheral devices 704 or the databases 706. Accordingly, the memory of processors 710, the memory/storage devices 720, the peripheral devices 704, and the databases 706 are examples of computer-readable and machine-readable media.

In embodiments, one or more components of FIGS. 5, 6, 7, 8, and/or 9, and particularly the baseband circuitry 504 of FIG. 7 (e.g., one or more of CPU 504E, 5G baseband processor 504C, and 4G baseband processor 504B), may be to: determine a gap measurement based on SNR or CQI feedback from a UE; determine a hysteresis for the UE based on the gap measurement, where the hysteresis is a detection latency or a threshold for consecutive BDS failures; and construct a signal to be sent to the UE, the signal to include an indication of the hysteresis.

In some embodiments, one of more components of FIGS. 5, 6, 7, 8, and/or 9, and particularly the baseband circuitry 504 (e.g., one or more of CPU 504E, 5G baseband processor 504C, and 4G baseband processor 504B) of FIG. 7, may be to: determine a gap measurement based on a SNR average or a CQI average for the wireless communications device; determine based on the gap measurement, a detection latency or a threshold for consecutive BDS failures; and identify a blockage event based on the determined detection latency or the threshold for consecutive BDS failures.

In some embodiments, one of more components of FIGS. 5, 6, 7, 8, and/or 9, and particularly the baseband circuitry 504 of FIG. 7, may include processing circuitry (e.g., one or more of CPU 504E, 5G baseband processor 504C, and 4G baseband processor 504B) to: determine a gap measurement based on a SNR or a CQI for a UE; determine a hysteresis for the UE based on the gap measurement, where the hysteresis is a detection latency or a threshold for consecutive BDS failures; and construct a signal to be sent to a wireless communications device, the signal to include an indication of the hysteresis; and memory (e.g., memory 504G), coupled with the processing circuitry, to store the indication of the hysteresis.

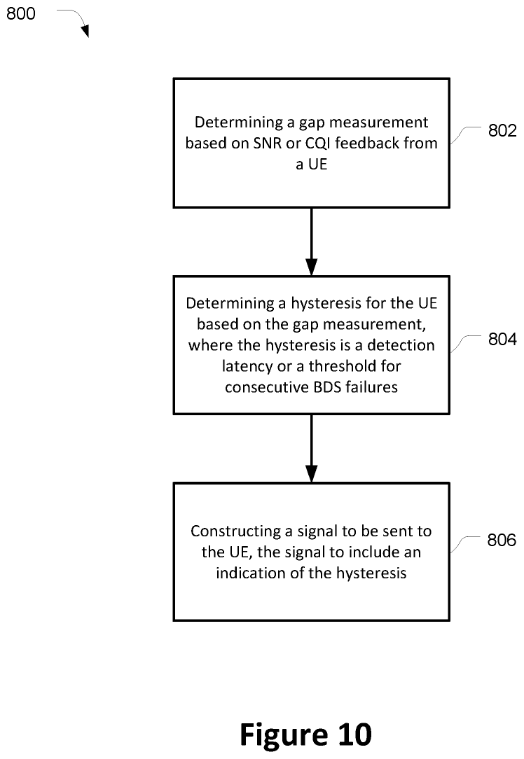

In some embodiments, the electronic device(s), network(s), system(s), chip(s), and/or component(s) or portions or implementations thereof, of FIGS. 5, 6, 7, 8, 9, and/or some other figure herein may be configured to perform one or more processes, techniques, and/or methods as described herein, or portions thereof. One such process is depicted in FIG. 10. For example, a process 800 may include: determining or causing to determine a gap measurement based on SNR or CQI feedback from a UE at a block 802; determining or causing to determine a hysteresis for the UE based on the gap measurement at a block 804, where the hysteresis is a detection latency or a threshold for consecutive BDS failures; and constructing or causing to construct a signal to be sent to the UE, the signal to include an indication of the hysteresis at a block 806.

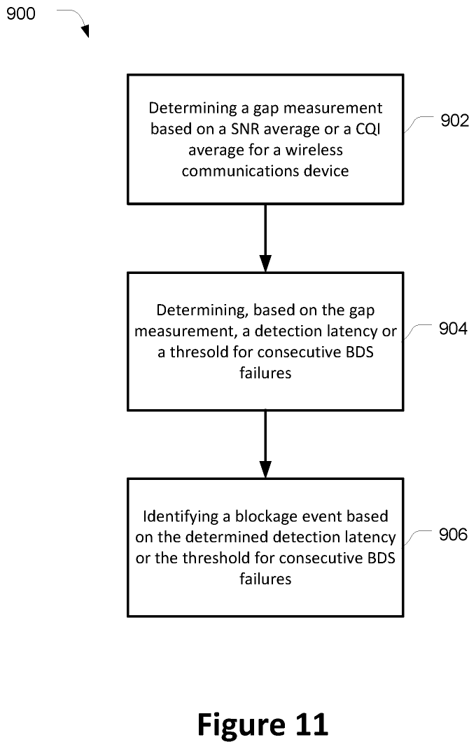

In some embodiments, the electronic device(s), network(s), system(s), chip(s), and/or component(s) or portions or implementations thereof, of FIGS. 5, 6, 7, 8, 9, and/or some other figure herein may be configured to perform one or more processes, techniques, and/or methods as described herein, or portions thereof. Another such process is depicted in FIG. 11. For example, a process 900 may include: determining or causing to determine a gap measurement based on a SNR average or a CQI average for a wireless communications device at a block 902; determining or causing to determine, based on the gap measurement, a detection latency or a threshold for consecutive BDS failures at a block 904; and identifying or causing to identify a blockage event based on the determined detection latency or the threshold for consecutive BDS failures a block 906.

The following paragraphs provide examples of various ones of the embodiments disclosed herein.

### EXAMPLES

Example 1 may include at least one computer-readable medium comprising instructions stored thereon that, in response to execution of the instructions by one or more processors cause a wireless communications device to: determine a gap measurement based on signal-to-noise ratio (“SNR”) or channel quality indicator (“CQI”) feedback from a user equipment (“UE”); determine a hysteresis for the UE based on the gap measurement, wherein the hysteresis is a detection latency or a threshold for consecutive blockage detection signal (“BDS”) failures; and construct a signal to be sent to the UE, the signal to include an indication of the hysteresis.

Example 2 may include the subject matter of Example 1 or any other example herein, wherein the instructions are further to cause the wireless communications device to identify a blockage event based on the hysteresis.

Example 3 may include the subject matter of Example 1 or any other example herein, wherein the gap measurement is a difference between a SNR average and an outage threshold, and wherein the hysteresis is inversely proportional to the difference between the SNR average and the outage threshold.

Example 4 may include the subject matter of Example 1 or any other example herein, wherein the instructions are further to cause the wireless communications device to determine a normalized gap based at least in part on a difference between a SNR average and an outage threshold, and a SNR variance for the UE, wherein the hysteresis is inversely proportional to the normalized gap.

Example 5 may include the subject matter of any one of Examples 1-4 or any other example herein, wherein the instructions are further to cause the wireless communications device to transmit the indication of the hysteresis to the UE with a unicast signal.

Example 6 may include the subject matter of any one of Examples 1-4 or any other example herein, wherein the instructions are further to cause the wireless communications device to transmit the indication of the hysteresis to the UE with a signal directed to a group of UEs.

Example 7 may include the subject matter of any one of Examples 1-4 or any other example herein, wherein the instructions are further to cause the wireless communications device to transmit the indication of the hysteresis to the UE via radio resource control (RRC) signaling, in a medium access control (MAC) control element, or over a physical channel.

Example 8 may include at least one computer-readable medium comprising instructions stored thereon that, in response to execution of the instructions by one or more processors cause a wireless communications device to: determine a gap measurement based on a signal-to-noise ratio (“SNR”) average or a channel quality indicator (“CQI”) average for the wireless communications device; determine, based on the gap measurement, a detection latency or a threshold for consecutive blockage detection signal (“BDS”) failures; and identify a blockage event based on the determined detection latency or the threshold for consecutive BDS failures.

Example 9 may include the subject matter of Example 8 or any other example herein, wherein the instructions are further to cause the wireless communications device to construct a signal to be sent to a wireless network, the signal to include an indication of the determined detection latency or the threshold for consecutive BDS failures.

Example 10 may include the subject matter of Example 9 or any other example herein, wherein the instructions are further to cause the wireless communications device to transmit the signal to an access node of the wireless network.

Example 11 may include the subject matter of Example 10 or any other example herein, wherein the instructions are also to cause the wireless communications device to transmit the signal to the access node by piggybacking on a CQI feedback procedure.

Example 12 may include the subject matter of Example 8 or any other example herein, wherein the instructions are further to cause the wireless communications device to determine a difference between the SNR average and an outage threshold, wherein the detection latency or the threshold for consecutive BDS failures is inversely proportional to a magnitude of the difference between the SNR average and the outage threshold.

Example 13 may include the subject matter of Example 8 or any other example herein, wherein the instructions are further to cause the wireless communications device to determine a normalized gap based at least in part on a difference between the SNR average and an outage threshold, and a SNR variance for the wireless communications device, wherein the detection latency or the threshold for consecutive BDS failures is inversely proportional to the normalized gap.

Example 14 may include the subject matter of Example 13 or any other example herein, wherein the SNR variance is based at least in part on a standard deviation of the SNR for the wireless communications device.

Example 15 may include the subject matter of any one of Examples 8-14 or any other example herein, wherein the instructions are also to cause the wireless communications device to perform a beam adaptation in response to the blockage event.

Example 16 may include the subject matter of any one of Examples 8-14 or any other example herein, wherein the instructions are to cause the wireless communications device to determine the detection latency or the threshold for consecutive BDS failures based at least in part on one or more indications in a signal broadcast by an access node that specify a channel quality indicator (“CQI”) to hysteresis mapping.

Example 17 may include a wireless communication apparatus comprising: processing circuitry to: determine a gap measurement based on a signal-to-noise ratio (“SNR”) or a channel quality indicator (“CQI”) for a user equipment (“UE”); determine a hysteresis for the UE based on the gap measurement, wherein the hysteresis is a detection latency or a threshold for consecutive blockage detection signal (“BDS”) failures; and construct a signal to be sent to a wireless communications device, the signal to include an indication of the hysteresis; and memory, coupled with the processing circuitry, to store the indication of the hysteresis.

Example 18 may include the subject matter of Example 17 or any other example herein, wherein the processing circuitry is further to identify a blockage event based on the hysteresis.

Example 19 may include the subject matter of Example 17 or any other example herein, wherein the processing circuitry is further to determine a difference between a SNR average and an outage threshold, wherein the hysteresis is inversely proportional to the difference between the SNR average and the outage threshold.

Example 20 may include the subject matter of Example 17 or any other example herein, wherein the processing circuitry is further to determine a normalized gap based at least in part on a difference between a SNR average and an outage threshold, and a SNR variance for the UE, wherein the hysteresis is inversely proportional to the normalized gap.

Example 21 may include the subject matter of any one of Examples 17-20 or any other example herein, wherein the wireless communication apparatus is a wireless network access node or a portion thereof and the wireless communications device is the UE.

Example 22 may include the subject matter of any one of Examples 17-20 or any other example herein, wherein the wireless communication apparatus is the UE or a portion thereof and the wireless communications device is a wireless network access node.

Example 23 may include the subject matter of any one of Examples 17-20 or any other example herein, wherein the processing circuitry is further to construct the signal to be sent to the wireless communications device for transmission via radio resource control (RRC) signaling, in a medium access control (MAC) control element, or over a physical channel.

Example 24 may include a wireless communication apparatus comprising: means for determining a gap measurement based on a signal-to-noise ratio (“SNR”) or a channel quality indicator (“CQI”) for a user equipment (“UE”); means for determining a hysteresis for the UE based on the gap measurement, wherein the hysteresis is a detection latency or a threshold for consecutive blockage detection signal (“BDS”) failures; and means for constructing a signal to be sent to a wireless communications device, the signal to include an indication of the hysteresis.

Example 25 may include the subject matter of Example 24 or any other example herein, wherein the means for determining the hysteresis includes means for determining a gap measurement between a signal-to-noise ratio (“SNR”) average and an outage threshold, wherein the hysteresis is based at least in part on the gap measurement.

Example 26 may include the subject matter of any one of Examples 24-25 or any other example herein, wherein the wireless communication apparatus is a wireless network access node or a portion thereof, and the wireless communications device is the UE.

Example 27 may include the subject matter of any one of Examples 24-25 or any other example herein, wherein the wireless communication apparatus is the UE or a portion thereof, and the wireless communications device is a wireless network access node.

Example 28 may include the subject matter of any one of Examples 24-25 or any other example herein, wherein the means for constructing the signal to be sent to the wireless communications device includes means for constructing the signal to be sent to the wireless communications device for transmission via radio resource control (RRC) signaling, in a medium access control (MAC) control element, or over a physical channel.

Example 29 may include a user equipment (“UE”) comprising: a means to calculate a detection latency for the UE using signal-to-noise ratio (“SNR”) statistics of the UE; and a means to inform a network about the detection latency.

Example 30 may include the UE of example 29 and/or some other example herein, wherein calculating the detection latency for the UE using SNR statistics of the UE comprises calculating a gap, wherein the detection latency is made inversely proportional to the gap, wherein the gap equals a difference between an average SNR of the UE and an outage threshold.

Example 31 may include the UE of example 29 and/or some other example herein, wherein calculating the detection latency for the UE using SNR statistics of the UE comprises calculating a normalized gap, wherein the detection latency is made inversely proportional to the normalized gap, wherein the normalized gap equals the gap divided by a standard deviation of the SNR.

Example 32 may include the UE of example 29 and/or some other example herein, wherein the means to inform the network about the detection latency comprises a means to inform the network through a unicast signal.

Example 33 may include the UE of example 29 and/or some other example herein, wherein the means to inform the network about the detection latency comprises a means to inform the network through a broadcast signal.

Example 34 may include the UE of example 29 and/or some other example herein, wherein the means to inform the network about the detection latency comprises a means to feed back the detection latency to an evolved NodeB (“eNB”).

Example 35 may include an eNB comprising: a means to determine detection latency information for a UE; and a means to specify the detection latency information to be used by at least one UE.

Example 36 may include the eNB of example 35 other example herein, wherein determining the detection latency information for the UE comprises determining a gap, wherein the detection latency is made inversely proportional to the gap, wherein the gap equals a difference between an average SNR of the UE and an outage threshold.

Example 37 may include the eNB of example 35 and/or some other example herein, wherein determining the detection latency information for the UE comprises determining a normalized gap, wherein the detection latency is made inversely proportional to the normalized gap, wherein the normalized gap equals the gap divided by a standard deviation of the SNR.

Example 38 may include the eNB of example 35 and/or some other example herein, wherein the detection latency information for the UE comprises a threshold for consecutive blockage detection signal failures.

Example 39 may include the eNB of example 35 and/or some other example herein, wherein the means to specify the detection latency information to be used by the at least one UE comprises a means to specify the detection latency information using a UE-specific signal.

Example 40 may include the eNB of example 35 and/or some other example herein, wherein the means to specify the detection latency information to be used by the at least one UE comprises a means to specify the detection latency information using a broadcast signal.

Example 41 may include the eNB of example 40 and/or some other example herein, wherein the means to specify the detection latency information using the broadcast signal comprises a means to broadcast a table mapping an SNR to a hysteresis.

Example 42 may include the eNB of example 35 and/or some other example herein, wherein the means to specify the detection latency information to be used by the at least one UE comprises a means to specify the latency information through a group-specific signal to a group of UEs.

Example 43 may include a mechanism where a UE specific time hysteresis is used for detecting blockage.

Example 44 may include a mechanism where the time hysteresis is inversely proportional to the SNR (“CQI”) of the UE.

Example 45 may include a mechanism where the time hysteresis is inversely proportional to the gap between the average SNR and the outage threshold of the UE.

Example 46 may include a mechanism where the time hysteresis is inversely proportional to the normalized gap, wherein the gap of example 45 is normalized by the standard deviation of SNR of UE.

Example 47 may include a unicast signal from eNB to UE specifying the hysteresis to be used along with the blockage detection signals.

Example 48 may include a group specific from eNB to UEs specifying the hysteresis to be used by UEs belonging to that specific group.

Example 49 may include a grouping technique where UEs with similar gap values of example 45 or similar normalized gap values of example 46 are grouped together.

Example 50 may include a broadcast signal from eNB to UEs specifying a table mapping the CQI to the hysteresis to be used for blockage detection.

Example 51 may include a feedback method carrying the detection latency information from UE to eNB.

Example 52 may include a method by which the exact procedure for blockage detection and hysteresis is configured by the network.

Example 53 may include an apparatus to: determine hysteresis information; and use a signal to transmit the hysteresis information.

Example 54 may include the apparatus of example 53 and/or some other example herein, wherein determining the hysteresis information comprises determining a gap, wherein the hysteresis information is made inversely proportional to the gap, wherein the gap equals a difference between an average SNR of the UE and an outage threshold.

Example 55 may include the eNB of example 53 and/or some other example herein, wherein determining the hysteresis information comprises determining a normalized gap, wherein the hysteresis information is made inversely proportional to the normalized gap, wherein the normalized gap equals the gap divided by a standard deviation of the SNR.

Example 56 may include the apparatus of example 53 and/or some other example herein, wherein the signal to transmit the hysteresis information comprises a unicast signal.

Example 57 may include the apparatus of example 53 and/or some other example herein, wherein the signal to transmit the hysteresis information comprises a broadcast signal.

Example 58 may include the apparatus of example 53 and/or some other example herein, wherein the hysteresis information comprises a first hysteresis information and the apparatus is further to identify or cause to be identified a received second hysteresis information.

Example 59 may include the apparatus of example 53 and/or some other example herein, wherein the apparatus comprises a UE.

Example 60 may include the apparatus of example 53 and/or some other example herein, wherein the apparatus comprises an eNB.

Example 61 may include a method of signal blockage detection, the method comprising: calculating or causing to calculate a detection latency for a UE; and sharing or causing to share the detection latency with a network.

Example 62 may include the method of example 61 and/or some other example herein, wherein calculating or causing to calculate the detection latency comprises calculating or causing to calculate a gap, wherein the detection latency is made inversely proportional to the gap, wherein the gap equals a difference between an average SNR of the UE and an outage threshold.

Example 63 may include the method of example 61 and/or some other example herein, wherein calculating or causing to calculate the detection latency comprises calculating or causing to calculate a normalized gap, wherein the detection latency is made inversely proportional to the normalized gap, wherein the normalized gap equals the gap divided by a standard deviation of the SNR.

Example 64 may include the method of example 61 and/or some other example herein, wherein sharing or causing to share the detection latency with the network comprises sharing or causing to share the detection latency with the network through a unicast signal.

Example 65 may include the method of example 61 and/or some other example herein, wherein sharing or causing to share the detection latency with the network comprises sharing or causing to share the detection latency with the network through a broadcast signal.

Example 66 may include the method of example 61 and/or some other example herein, wherein sharing or causing to share the detection latency with the network comprises feeding back or causing to feed back the detection latency to an eNB.

Example 67 may include a method of signal blockage detection, the method comprising: estimating or causing to estimate detection latency information; and informing or causing to estimate the detection latency information to at least one UE.

Example 68 may include the method of example 67 and/or some other example herein, wherein estimating or causing to estimate the detection latency information comprises estimating or causing to estimate a gap, wherein the detection latency information is made inversely proportional to the gap, wherein the gap equals a difference between an average SNR of the UE and an outage threshold.

Example 69 may include the method of example 67 and/or some other example herein, wherein estimating or causing to estimate the detection latency information comprises estimating or causing to estimate a normalized gap, wherein the detection latency information is made inversely proportional to the normalized gap, wherein the normalized gap equals the gap divided by a standard deviation of the SNR.

Example 70 may include the method of example 67 and/or some other example herein, wherein estimating or causing to estimate the detection latency information comprises estimating or causing to estimate a maximum hysteresis to be used by the at least one UE.

Example 71 may include the method of example 67 and/or some other example herein, wherein estimating or causing to estimate the detection latency information comprises estimating or causing to estimate a total time duration during which a blockage condition is expected to hold.

Example 72 may include the method of example 67 and/or some other example herein, wherein informing or causing to inform the detection latency information to the at least one UE comprises informing or causing to inform the detection latency information using a unicast signal.

Example 73 may include the method of example 67 and/or some other example herein, wherein informing or causing to inform the detection latency information to the at least one UE comprises informing or causing to inform the detection latency information using a broadcast signal.

Example 74 may include the method of example 73 and/or some other example herein, wherein informing or causing to inform the detection latency information using the broadcast signal comprises broadcasting a table mapping a channel quality indicator to a hysteresis.

Example 75 may include the method of example 67 and/or some other example herein, further comprising grouping or causing to group UEs with a similar average SNR, standard deviation of SNR values, gap, or normalized gap.

Example 76 may include the method of example 75 and/or some other example herein, wherein informing or causing to inform the detection latency information to the at least one UE comprises informing or causing to inform the detection latency information using a group-specific signal to a group of UEs.

Example 77 may include a method comprising: determining a gap measurement based on signal-to-noise ratio (“SNR”) or channel quality indicator (“CQI”) feedback from a user equipment (“UE”); determining a hysteresis for the UE based on the gap measurement, wherein the hysteresis is a detection latency or a threshold for consecutive blockage detection signal (“BDS”) failures; and constructing a signal to be sent to the UE, the signal to include an indication of the hysteresis.

Example 78 may include the subject matter of Example 77 or any other example herein, wherein the method further includes identifying a blockage event based on the hysteresis.

Example 79 may include the subject matter of Example 77 or any other example herein, wherein the gap measurement is a difference between a SNR average and an outage threshold, and wherein the hysteresis is inversely proportional to the difference between the SNR average and the outage threshold.

Example 80 may include the subject matter of Example 747 or any other example herein, wherein the method further includes determining a normalized gap based at least in part on a difference between a SNR average and an outage threshold, and a SNR variance for the UE, wherein the hysteresis is inversely proportional to the normalized gap.

Example 81 may include the subject matter of any one of Examples 77-80 or any other example herein, wherein the method further includes transmitting the indication of the hysteresis to the UE with a unicast signal.

Example 82 may include the subject matter of any one of Examples 77-80 or any other example herein, wherein the method further includes transmitting the indication of the hysteresis to the UE with a signal directed to a group of UEs.

Example 83 may include a method comprising: determining a gap measurement based on a signal-to-noise ratio (“SNR”) average or a channel quality indicator (“CQI”) average for the wireless communications device; determining, based on the gap measurement, a detection latency or a threshold for consecutive blockage detection signal (“BDS”) failures; and identifying a blockage event based on the determined detection latency or the threshold for consecutive BDS failures.

Example 84 may include the subject matter of Example 83 or any other example herein, wherein the method further includes constructing a signal to be sent to a wireless network, the signal to include an indication of the determined detection latency or the threshold for consecutive BDS failures.

Example 85 may include the subject matter of Example 84 or any other example herein, wherein the method further includes transmitting the signal to an access node of the wireless network.

Example 86 may include the subject matter of Example 85 or any other example herein, wherein the method further includes transmitting the signal to the access node by piggybacking on a CQI feedback procedure.

Example 87 may include the subject matter of Example 83 or any other example herein, wherein the method further includes determining a difference between the SNR average and an outage threshold, wherein the detection latency or the threshold for consecutive BDS failures is inversely proportional to a magnitude of the difference between the SNR average and the outage threshold.

Example 88 may include the subject matter of Example 83 or any other example herein, wherein the method further includes determining a normalized gap based at least in part on a difference between the SNR average and an outage threshold, and a SNR variance for the wireless communications device, wherein the detection latency or the threshold for consecutive BDS failures is inversely proportional to the normalized gap.

Example 89 may include the subject matter of Example 88 or any other example herein, wherein the SNR variance is based at least in part on a standard deviation of the SNR for the wireless communications device.

Example 90 may include the subject matter of any one of Examples 83-89 or any other example herein, wherein the method further includes performing a beam adaptation in response to the blockage event.

Example 91 may include the subject matter of any one of Examples 83-89 or any other example herein, wherein the method further includes determining the detection latency or the threshold for consecutive BDS failures based at least in part on one or more indications in a signal broadcast by an access node that specify a channel quality indicator (CQI) to hysteresis mapping.

Example 92 may include a method comprising: determining a gap measurement based on a signal-to-noise ratio (“SNR”) or a channel quality indicator (“CQI”) for a user equipment (“UE”); determining a hysteresis for the UE based on the gap measurement, wherein the hysteresis is a detection latency or a threshold for consecutive blockage detection signal (“BDS”) failures; constructing a signal to be sent to a wireless communications device, the signal to include an indication of the hysteresis; and storing the indication of the hysteresis in a memory.

Example 93 may include the subject matter of Example 92 or any other example herein, wherein the method further includes identifying a blockage event based on the hysteresis.

Example 94 may include the subject matter of Example 92 or any other example herein, wherein the method further includes determining a difference between a SNR average and an outage threshold, wherein the hysteresis is inversely proportional to the difference between the SNR average and the outage threshold.

Example 95 may include the subject matter of Example 92 or any other example herein, wherein the method further includes determining a normalized gap based at least in part on a difference between a SNR average and an outage threshold, and a SNR variance for the UE, wherein the hysteresis is inversely proportional to the normalized gap.

Example 96 may include the subject matter of any one of Examples 92-95 or any other example herein, wherein the method is performed by a wireless network access node or a portion thereof and the wireless communications device is the UE.

Example 97 may include the subject matter of any one of Examples 92-95 or any other example herein, wherein the method is performed by the UE or a portion thereof and the wireless communications device is a wireless network access node

Example 98 may include an apparatus comprising means to perform one or more elements of a method described in or related to any of examples 1-97, or any other method or process described herein.

Example 99 may include one or more non-transitory computer-readable media comprising instructions to cause an electronic device, upon execution of the instructions by one or more processors of the electronic device, to perform one or more elements of a method described in or related to any of examples 1-97, or any other method or process described herein.

Example 100 may include an apparatus comprising logic, modules, and/or circuitry to perform one or more elements of a method described in or related to any of examples 1-97, or any other method or process described herein.

Example 101 may include a method, technique, or process as described in or related to any of examples 1-97, or portions or parts thereof.

Example 102 may include an apparatus comprising: one or more processors and one or more computer readable media comprising instructions that, when executed by the one or more processors, cause the one or more processors to perform the method, techniques, or process as described in or related to any of examples 1-97, or portions thereof.

Example 103 may include a method of communicating in a wireless network as shown and described herein.

Example 104 may include a system for providing wireless communication as shown and described herein.

Example 105 may include a device for providing wireless communication as shown and described herein.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

1. At least one non-transitory, computer-readable medium comprising instructions stored thereon that, in response to execution of the instructions by one or more processors cause a wireless communications device to:
determine a gap measurement based on signal-to-noise ratio (“SNR”) or channel quality indicator (“CQI”) feedback from a user equipment (“UE”);
determine a hysteresis for the UE based on the gap measurement, wherein the hysteresis is a detection latency or a threshold for consecutive blockage detection signal (“BDS”) failures; and
construct a signal to be sent to the UE, the signal to include an indication of the hysteresis.

2. The at least one non-transitory, computer-readable medium of claim 1, wherein the instructions are further to cause the wireless communications device to identify a blockage event based on the hysteresis.

3. The at least one non-transitory, computer-readable medium of claim 1, wherein the gap measurement is a difference between a SNR average and an outage threshold, and wherein the hysteresis is inversely proportional to the difference between the SNR average and the outage threshold.

4. The at least one non-transitory, computer-readable medium of claim 1, wherein the instructions are further to cause the wireless communications device to determine a normalized gap based at least in part on a difference between a SNR average and an outage threshold, and a SNR variance for the UE, wherein the hysteresis is inversely proportional to the normalized gap.

5. The at least one non-transitory, computer-readable medium of claim 1, wherein the instructions are further to cause the wireless communications device to transmit the indication of the hysteresis to the UE with a unicast signal.

6. The at least one non-transitory, computer-readable medium of claim 1, wherein the instructions are further to cause the wireless communications device to transmit the indication of the hysteresis to the UE with a signal directed to a group of UEs.

7. The at least one non-transitory, computer-readable medium of claim 1, wherein the instructions are further to cause the wireless communications device to transmit the indication of the hysteresis to the UE via radio resource control (RRC) signaling, in a medium access control (MAC) control element, or over a physical channel.

8. At least one non-transitory, computer-readable medium comprising instructions stored thereon that, in response to execution of the instructions by one or more processors cause a wireless communications device to:
determine a gap measurement based on a signal-to-noise ratio (“SNR”) average or a channel quality indicator (“CQI”) average for the wireless communications device;
determine, based on the gap measurement, a detection latency or a threshold for consecutive blockage detection signal (“BDS”) failures; and
identify a blockage event based on the determined detection latency or the threshold for consecutive BDS failures.

9. The at least one non-transitory, computer-readable medium of claim 8, wherein the instructions are further to cause the wireless communications device to construct a signal to be sent to a wireless network, the signal to include an indication of the determined detection latency or the threshold for consecutive BDS failures.

10. The at least one non-transitory, computer-readable medium of claim 9, wherein the instructions are further to cause the wireless communications device to transmit the signal to an access node of the wireless network.

11. The at least one non-transitory, computer-readable medium of claim 10, wherein the instructions are also to cause the wireless communications device to transmit the signal to the access node by piggybacking on a CQI feedback procedure.

12. The at least one non-transitory, computer-readable medium of claim 8, wherein the instructions are further to cause the wireless communications device to determine a difference between the SNR average and an outage threshold, wherein the detection latency or the threshold for consecutive BDS failures is inversely proportional to a magnitude of the difference between the SNR average and the outage threshold.

13. The at least one non-transitory, computer-readable medium of claim 8, wherein the instructions are further to cause the wireless communications device to determine a normalized gap based at least in part on a difference between the SNR average and an outage threshold, and a SNR variance for the wireless communications device, wherein the detection latency or the threshold for consecutive BDS failures is inversely proportional to the normalized gap.

14. The at least one non-transitory, computer-readable medium of claim 13, wherein the SNR variance is based at least in part on a standard deviation of the SNR for the wireless communications device.

15. The at least one non-transitory, computer-readable medium of claim 8, wherein the instructions are also to cause the wireless communications device to perform a beam adaptation in response to the blockage event.

16. The at least one non-transitory, computer-readable medium of claim 8, wherein the instructions are to cause the wireless communications device to determine the detection latency or the threshold for consecutive BDS failures based at least in part on one or more indications in a signal broadcast by an access node that specify a channel quality indicator (“CQI”) to hysteresis mapping.

17. A wireless communication apparatus comprising:
processing circuitry to:
determine a gap measurement based on a signal-to-noise ratio (“SNR”) or a channel quality indicator (“CQI”) for a user equipment (“UE”);
determine a hysteresis for the UE based on the gap measurement, wherein the hysteresis is a detection latency or a threshold for consecutive blockage detection signal (“BDS”) failures; and
construct a signal to be sent to a wireless communications device, the signal to include an indication of the hysteresis; and
memory, coupled with the processing circuitry, to store the indication of the hysteresis.

18. The wireless communication apparatus of claim 17, wherein the processing circuitry is further to identify a blockage event based on the hysteresis.

19. The wireless communication apparatus of claim 17, wherein the processing circuitry is further to determine a difference between a SNR average and an outage threshold, wherein the hysteresis is inversely proportional to the difference between the SNR average and the outage threshold.

20. The wireless communication apparatus of claim 17, wherein the processing circuitry is further to determine a normalized gap based at least in part on a difference between a SNR average and an outage threshold, and a SNR variance for the UE, wherein the hysteresis is inversely proportional to the normalized gap.

21. The wireless communication apparatus of claim 17, wherein the wireless communication apparatus is a wireless network access node or a portion thereof and the wireless communications device is the UE.

22. The wireless communication apparatus of claim 17, wherein the wireless communication apparatus is the UE or a portion thereof and the wireless communications device is a wireless network access node.

23. The wireless communication apparatus of claim 17, wherein the processing circuitry is further to construct the signal to be sent to the wireless communications device for transmission via radio resource control (RRC) signaling, in a medium access control (MAC) control element, or over a physical channel.

24. A wireless communication apparatus comprising:
means for determining a gap measurement based on a signal-to-noise ratio (“SNR”) or a channel quality indicator (“CQI”) for a user equipment (“UE”);
means for determining a hysteresis for the UE based on the gap measurement, wherein the hysteresis is a detection latency or a threshold for consecutive blockage detection signal (“BDS”) failures; and
means for constructing a signal to be sent to a wireless communications device, the signal to include an indication of the hysteresis.

25. The wireless communication apparatus of claim 24, wherein the means for determining the hysteresis includes means for determining a gap measurement between a signal-to-noise ratio (“SNR”) average and an outage threshold, wherein the hysteresis is based at least in part on the gap measurement.

26-28. (canceled)
